(19) United States
(12) Patent Application Publication
(10) Pub. No.: US 2014/0061290 A1
(43) Pub. Date: Mar. 6, 2014

(54) METHOD AND APPARATUS FOR STORING A CUSTOMER IDENTIFYING INFORMATION IN A CONSUMABLE TO BE USED IN AN IMAGE PRODUCTION DEVICE

(71) Applicants: Andrew Scott BRADFORD, Rockester, NY (US); Heiko ROMMELMANN, Penfield, NY (US)

(72) Inventors: Andrew Scott BRADFORD, Rockester, NY (US); Heiko ROMMELMANN, Penfield, NY (US)

(73) Assignee: XEROX CORPORATION, Norwlk, CT (US)

(21) Appl. No.: 13/597,880

(22) Filed: Aug. 29, 2012

(51) Int. Cl. G06K 19/00; G06K 19/06

(52) U.S. Cl. 235/375; 235/487; 235/494

(57) ABSTRACT

A method and apparatus for storing a customer identifying information in a consumable used in an image production device is disclosed. The method may include receiving an order from a customer for one or more consumables, each of the one or more consumables having a tag memory, retrieving customer identifying information relating to the customer, storing the retrieved customer identifying information in the tag memory of each of the ordered one or more consumables, and sending the ordered one or more consumables to the customer corresponding to the customer identifying information stored in the tag memory of each of the ordered one or more consumables.

### BACKGROUND

Disclosed herein is a method for storing a customer identifying information in a consumable used in an image production device, as well as corresponding apparatus and computer-readable medium.

Through the box programming of tag memory devices that may be associated with a consumable to be used in an image production device, such as, but not limited to, a toner cartridge, may allow the tag memory device to have information stored in the tag memory at a distribution center just before shipment to a customer.

Toner and other consumables currently ship to customers with a minimal amount of customer identifiable information stored in the tag memories, usually a geographic identifier and a contract identifier (e.g., whether the intended image production device is either metered or sold). Any customer image production device conforming to these limited identifiers can use any consumable having matching identifiers. This situation provides the opportunity for pricing arbitrage and grey market activities including the moving of consumables from one customer to another customer that operates outside the control of the consumable or image production device manufacturer or distributor.

### SUMMARY

A method and apparatus for storing a customer identifying information in a consumable used in an image production device is disclosed. The method may include receiving an order from a customer for one or more consumables, each of the one or more consumables having a tag memory, retrieving customer identifying information relating to the customer, storing the retrieved customer identifying information in the tag memory of each of the ordered one or more consumables, and sending the ordered one or more consumables to the customer corresponding to the customer identifying information stored in the tag memory of each of the ordered one or more consumables.

### BRIEF DESCRIPTION OF THE DRAWINGS

FIG. 1 is an exemplary diagram of an image production device in accordance with one possible embodiment of the disclosure;

FIG. 2 is an exemplary block diagram of an image production device in accordance with one possible embodiment of the disclosure;

FIG. 3 is an exemplary block diagram of the consumable package processing unit in accordance with one possible embodiment of the disclosure;

FIG. 4 is a flowchart of an exemplary process for storing a customer identifying information in a consumable's tag memory to be used in an image production device in accordance with one possible embodiment of the disclosure; and

FIG. 5 is a flowchart of an exemplary process for verifying the customer identifying information stored in a consumable with the customer identifying information stored in an image production device in accordance with one possible embodiment of the disclosure.

### DETAILED DESCRIPTION

Aspects of the embodiments disclosed herein relate to storing a customer identifying information in a consumable used in an image production device, as well as corresponding apparatus and method of verifying customer identifying information at the image production device.

The disclosed embodiments may include a method for storing a customer identifying information in a consumable used in an image production device. The method may include receiving an order from a customer for one or more consumables, each of the one or more consumables having a tag memory, retrieving customer identifying information relating to the customer, storing the retrieved customer identifying information in the tag memory of each of the ordered one or more consumables, and sending the ordered one or more consumables to the customer corresponding to the customer identifying information stored in the tag memory of each of the ordered one or more consumables.

The disclosed embodiments may further include an apparatus for storing a customer identifying information in a consumable used in an image production device that may include a communication interface that facilitates sending and receiving communications, and an automatic customer identifying information storing unit that receives an order from a customer for one or more consumables through the communication interface, each of the one or more consumables having a tag memory, retrieves customer identifying information relating to the customer, stores the retrieved customer identifying information in the tag memory of each of the ordered one or more consumables, and sends the ordered one or more consumables to the customer corresponding to the customer identifying information stored in the tag memory of each ordered one or more consumables.

The disclosed embodiments may include a method of verifying a customer identifying information for a consumable to be used in an image production device. The method may include determining that an installed consumable is being replaced in the image production device by a replacement consumable, the image production device having customer identifying information stored in its memory and the replacement consumable having a tag memory that stores customer identifying information, reading the tag memory on the replacement consumable to determine the customer identifying information stored in the tag memory, determining if the customer identifying information stored in the image production device's memory matches the customer identifying information stored in the replacement consumable's tag memory, wherein if it is determined that the customer identifying information stored in the image production device's memory does not match the customer identifying information stored in the replacement consumable's tag memory, notifying the customer that there is an unauthorized replacement consumable attempting to be installed in the image production device, and not permitting the image production device to operate until the unauthorized replacement consumable is removed and a replacement consumable that has customer identifying information stored in its tag memory that matches the customer identifying information stored in the image production device's memory is installed, wherein if it is determined that the customer identifying information stored in the image production device's memory matches the customer identifying information stored in the replacement consumable's tag memory, allowing the replacement consumable to be installed and the image production device to operate after installation of the replacement consumable.

The disclosed embodiments may include an image production device that may include a memory that stores customer identifying information for the image production device, a tag memory reading device that reads a tag memory on a replacement consumable to determine the customer identifying information stored in the tag memory, a consumable management unit that determines that an installed consumable is being replaced in the image production device by a replacement consumable, receives the customer identifying information stored in the tag memory from the tag memory reading device, determines if the customer identifying information stored in the image production device's memory matches the customer identifying information stored in the replacement consumable's tag memory, wherein if the consumable management unit determines that the customer identifying information stored in the image production device's memory does not match the customer identifying information stored in the replacement consumable's tag memory, the consumable management unit notifies the customer that there is an unauthorized replacement consumable attempting to be installed in the image production device, and does not permit the image production device to operate until the unauthorized replacement consumable is removed and a replacement consumable that has customer identifying information stored in its tag memory that matches the customer identifying information stored in the image production device's memory is installed, wherein if the consumable management unit determines that the customer identifying information stored in the image production device's memory matches the customer identifying information stored in the replacement consumable's tag memory, the consumable management unit allows the replacement consumable to be installed and the image production device to operate after installation of the replacement consumable.

Image production devices, such as, but not included to, multi-function printers (MFPs) and standalone printers may include information concerning the consumables (or customer replaceable units, such as, but not limited to, a toner cartridge). Through the box programming of tag memory devices that may be associated with a consumable to be used in an image production device may allow information to be stored on the tag memory device (or Customer Replaceable Unit Monitor (CRUM)) on the consumable at a distribution center just before shipment to a customer. By utilizing through the box programming at a distribution center, additional flexibility can be achieved at manufacturing and distribution sites. There is also the opportunity to reduce total inventories held at distribution centers. Through the box programming entails only changes to a manufacturing process of consumables and a modification of processes used at distribution centers.

The changes at distribution sites to support through the box programming require a different method for picking a product for shipment. Currently, as orders arrive at the distribution center, an operator will pick the proper parts from inventory stockpiles and assemble the order for shipment. This process must change to accommodate through the box programming because as each item that utilizes through the box programming methods is picked, it must have the customer identifying information stored in the tag memory before it can be shipped to a customer.

Once the tag memory programming is changed at the manufacturing or distribution center, embodiments of the present disclosure provide a quick, effective, and easy method for storing the customer identifying information or other information in the consumable's tag memory.

The ability to program a tag memory “through the box” utilizes techniques found in many previous patents of the inventors. For example, the ability for through the box programming of tag memory devices that may be associated with a consumable to be used in an image production device is described in detail in U.S. Pat. No. 7,196,627, entitled, CONTROL OF PACKAGED MODULES and assigned to the assignee of the present application. This patent is incorporated herein by reference.

The '627 patent describes processing a module packaged within a container and involves securely affixing a tag comprising a tag memory and a tag communication element to the container. While the module is enclosed in the container, information pertaining to the module is selectively stored in the tag memory for later readout and processing. A container for enclosing a module includes an electronic tag having a tag memory and a tag communication element. The tag communication element is adapted to receive information from a source, and the tag memory stores that information. While the module is packaged in the container, either first module information or second module information is stored in the tag memory. The module information pertains to the subsequent use of the module. The electronic tag is embedded in the container material, or securely affixed to the container. The electronic tag may span a container opening so that the tag is damaged upon opening the container, providing security against improper re-use.

According to the disclosed embodiments, each image production device (e.g., a printer or a copier) provided to a single customer may have the same customer identifying information programmed into its memory. This unique customer identifying information may be shared among all machines used by a customer within a geographic region and/or under the same contract type (“metered” or “sold”). No two customers may share a common customer identifying information. As additional image production devices are added to a customer's account, the additional image production devices may also be programmed with the same customer identifying information.

For example, when a customer places an order for consumable supplies (i.e., toner, drums, coffee vending machine consumables, etc.), as the order is filled in the manufacturing or distribution center warehouse, the customer identifying information associated with the customer placing the order will be programmed into the consumable's tag memory (such as a Radio Frequency Identification Device).

In an embodiment of the disclosure, the customer identifying information may be included with other information be determined based on whether the image production device is either owned by the user, owned by the manufacturer, or owned by a distribution entity, for example. The customer identifying information may also be stored in the tag memory using one of a hand held programming fixture and a fixed-place programming fixture, for example.

The packaging may comprise packaging material and the customer identifying information may be stored in the tag memory through the packaging material. The packaging material may include at least one of a box, paper, and synthetic material, for example.

For example, as the consumable is picked from inventory at the distribution center warehouse, it could be placed into a programming fixture. This programming fixture may read the customer identifying information from the order database to determine the value of the customer identifying information. The fixture may then program the customer identifying information into the consumable's tag memory. Once programming of the tag memory is complete, the consumable could be assembled with the rest of the customer's ordered items for shipment, for example.

When the consumable arrives at the customer's site and is installed into an image production device, the image production device may validate that the customer identifiable information in the tag memory matches the customer identifying information stored in its memory. If the values do not match, the image production device could alert the user or prevent the consumable from being used. This validation would be in addition to existing validations that occur to ensure that the consumable is a valid product and that the consumable is being used in an image production device in the proper geographic location and under the proper contract type (metered or sold).

By utilizing the customer identifying information within a consumable's tag memory, consumables provided to one customer cannot be used by another customer. This process helps prevent customers from engaging in grey market activities such as supplies pricing arbitrage or from metered accounts “leaking” supplies to other customers, for example.

Under the disclosed embodiments:

Customer identifiable information is programmed into each customer image production device.

Each consumable has ordering customer's customer identifiable information programmed into its tag memory at the time of consumable order fulfillment.

Upon consumable insertion, machine checks that the tag memory contains the same customer identifiable information as itself before recognizing the consumable as usable.

The benefits of the disclosed embodiments include:

Prevents usage of consumables by anyone other than the original purchaser (sold contract) or entity to which the consumable is originally provided (metered contract).

Reduces grey market movement of consumables.

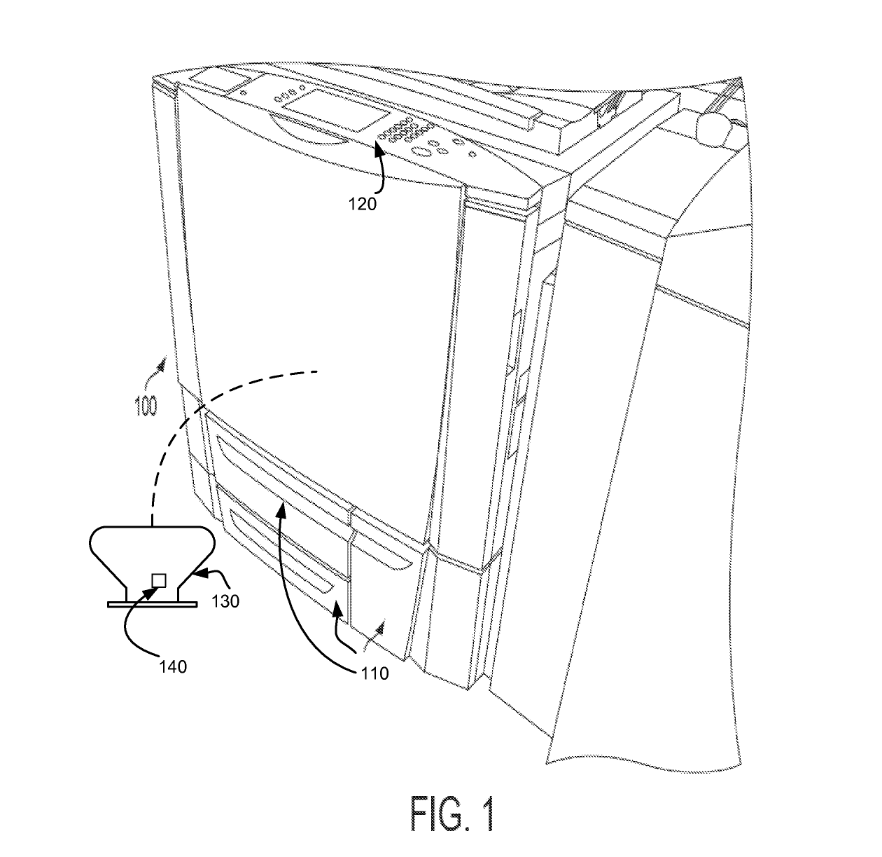

FIG. 1 is an exemplary diagram of an image production device 100 for which a consumable 130, such as a toner cartridge may be used in accordance with one possible embodiment of the disclosure. The image production device 100 may be any device that may be capable of making image production documents (e.g., printed documents, copies, etc.) including a copier, a printer, a facsimile device, and a multi-function device (MFD), for example.

The image production device 100 may include one or more media tray doors 110 and a local user interface 120. The one or more media tray doors 110 may provide access to one or more media trays that contain media and may provide access to consumable 130. Consumable 130 may be any item including cartridges, components, etc. that may be periodically replaced by the user or maintenance personal when required, consumed, or they have reached their end-of-life (EOL). Examples of consumables 130 may be toner cartridges, ink cartridges, imaging drums, etc. Consumables 130 are typically posted to customer sites as required, usually this supply may be controlled by the consumable management unit monitoring the life of the consumable 130 and requesting a re-order as necessary. The consumable 130 may include a tag memory 140 which may be located in a variety of places on the consumable 130. The tag memory 140 may be any type of memory device that may be able to store specific consumable and customer information, such as an RFID, for example. The tag memory 140 may store customer identifying information which may be a sequence of numbers, a sequence of letters, a sequence of letters and numbers, a data glyph, a bar code, metering information or purchase information, for example.

The user interface 120 may contain one or more display screens (which may be a touchscreen or simply a display), and a number of buttons, knobs, switches, etc. to be used by a user to control image production device 100 operations. The one or more display screen may also display warnings, alerts, instructions, and information to a user. While the user interface 120 may accept user inputs, another source of image data and instructions may include inputs from any number of computers to which the printer is connected via a network.

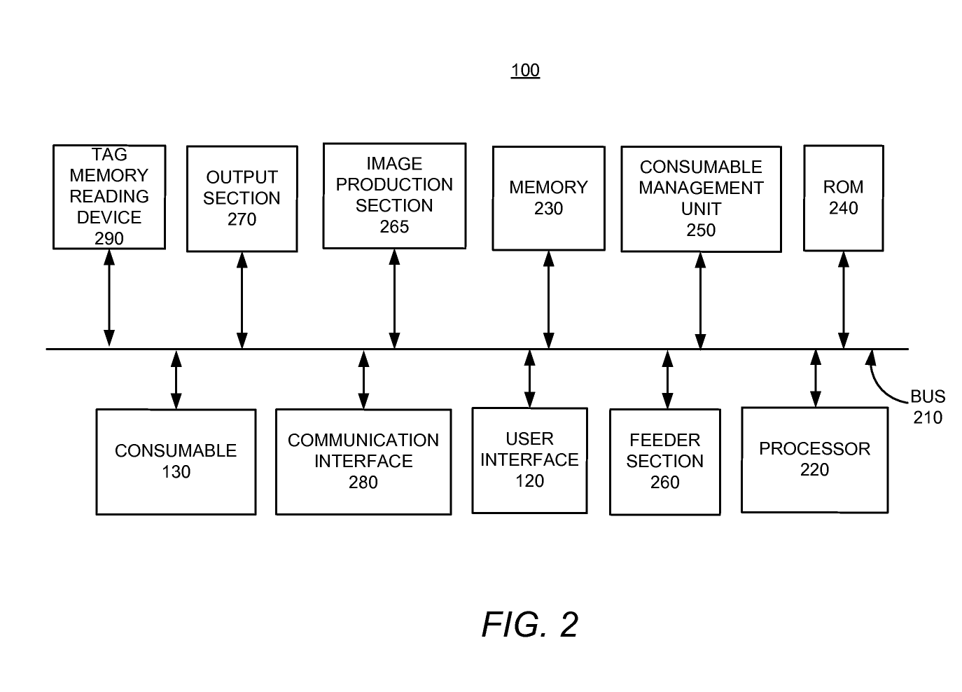

FIG. 2 is an exemplary block diagram of an image production device 100 in accordance with one possible embodiment of the disclosure. FIG. 2 is an exemplary block diagram of the image production device 100 in accordance with one possible embodiment of the disclosure. The image production device 100 may include a bus 210, a processor 220, a memory 230, a read only memory (ROM) 240, a consumable management unit 250, a feeder section 260, an output section 270, a user interface 120, a communication interface 280, one or more consumables 130, an image production section 265, and a tag memory reading device 295. Bus 210 may permit communication among the components of the image production device 100.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

Communication interface 280 may include any mechanism that facilitates communication via a network. For example, communication interface 280 may include a modem. Alternatively, communication interface 280 may include other mechanisms for assisting in communications with other devices and/or systems.

ROM 240 may include a conventional ROM device or another type of static storage device that stores static information and instructions for processor 220. A storage device may augment the ROM and may include any type of storage media, such as, for example, magnetic or optical recording media and its corresponding drive.

The image production section 265 may include hardware to produce image on media and may include an image printing and/or copying section, a scanner, a fuser, etc., for example. The feeder section 260 may be stand-alone or integrated and may store and dispense media sheets on which images are to be printed. The output section 270 may include hardware for stacking, folding, stapling, binding, etc., prints which are output from the image production section. If the image production device 100 is also operable as a copier, the image production device 100 may further includes a document feeder and scanner which may operate to convert signals from light reflected from original hard-copy image into digital signals, which are in turn processed to create copies with the image production section 265.

With reference to feeder section 260, the section may include one or more media trays, each of which stores a media stack or print sheets (“media”) of a predetermined type (size, weight, color, coating, transparency, etc.) and may include a feeder to dispense one of the media sheets therein as instructed. The media trays may be accessed by a user by opening the one or more media tray doors 110. The one or more media tray door sensors may sense if one or more media tray door 110 is either open or closed. The one or more media tray door sensors may be any sensors known to one of skill in the art, such as contact, infra-red, magnetic, or light-emitting diode (LED) sensors, for example. The one or more media tray size sensors may be any sensors that may detect media size in a media known to one of skill in the art, including switches, etc.

User interface 120 may include one or more conventional mechanisms that permit a user to input information to and interact with the image production device 100, such as a keyboard, a display, a mouse, a pen, a voice recognition device, touchpad, buttons, etc., for example. Output section 270 may include one or more conventional mechanisms that output image production documents to the user, including output trays, output paths, finishing section, etc., for example.

Consumables 130 may be any item including cartridges, components, etc. that may be periodically replaced by the user or maintenance personal when required, consumed, or they have reached their end-of-life (EOL). Examples of consumables 130 may be toner cartridges, ink cartridges, imaging drums, dry ink, solid ink, ink sticks (solid ink and ink stick have a unique consumable tagging process and consumable management unit 250 monitoring process known to those of skill in the art), etc. FIG. 1 shows an exemplary diagram of a consumable 130 in the form of a toner bottle in accordance with one possible embodiment of the disclosure.

Consumables 130 are typically posted to customer sites as required, and usually this supply may be controlled by the consumable management unit 250 monitoring the life of the consumable 130 and requesting a re-order as necessary. Consumable management unit 250 technology may define a process by which the state or status of consumables 130 may be monitored to enhance the efficiency or productivity of the image production device 100 on which it is installed. For example, consider the toner cartridge of the image production device 100 where the consumable management unit 250 may monitor the amount of toner remaining. The consumable management unit 250 may provide feedback to the image production device 100 as to the number of copies that can be made before a toner cartridge replacement is required. For example, if a user selects a copy quantity in excess of what can be printed, the user can be alerted so that appropriate action may be taken. This technology may be applicable to all image production device 100 subsystems which contain consumables 130, for example.

The tag memory reading device 295 may be any device that may read and decode or decipher information stored on a tag memory 140 (e.g., an RFID device) of a consumable 130, such as an RFID reader, bar code reader, glyph or symbol reader, etc.

The image production device 100 may perform such functions in response to processor 220 by executing sequences of instructions contained in a computer-readable medium, such as, for example, memory 230. Such instructions may be read into memory 230 from another computer-readable medium, such as a storage device or from a separate device via communication interface 280.

The image production device 100 illustrated in FIGS. 1-2 and the related discussion are intended to provide a brief, general description of a suitable communication and processing environment in which the disclosure may be implemented. Although not required, the disclosure will be described, at least in part, in the general context of computer-executable instructions, such as program modules, being executed by the image production device 100, such as a communication server, communications switch, communications router, or general purpose computer, for example.

Generally, program modules include routine programs, objects, components, data structures, etc. that perform particular tasks or implement particular abstract data types. Moreover, those skilled in the art will appreciate that other embodiments of the disclosure may be practiced in communication network environments with many types of communication equipment and computer system configurations, including personal computers, hand-held devices, multi-processor systems, microprocessor-based or programmable consumer electronics, and the like.

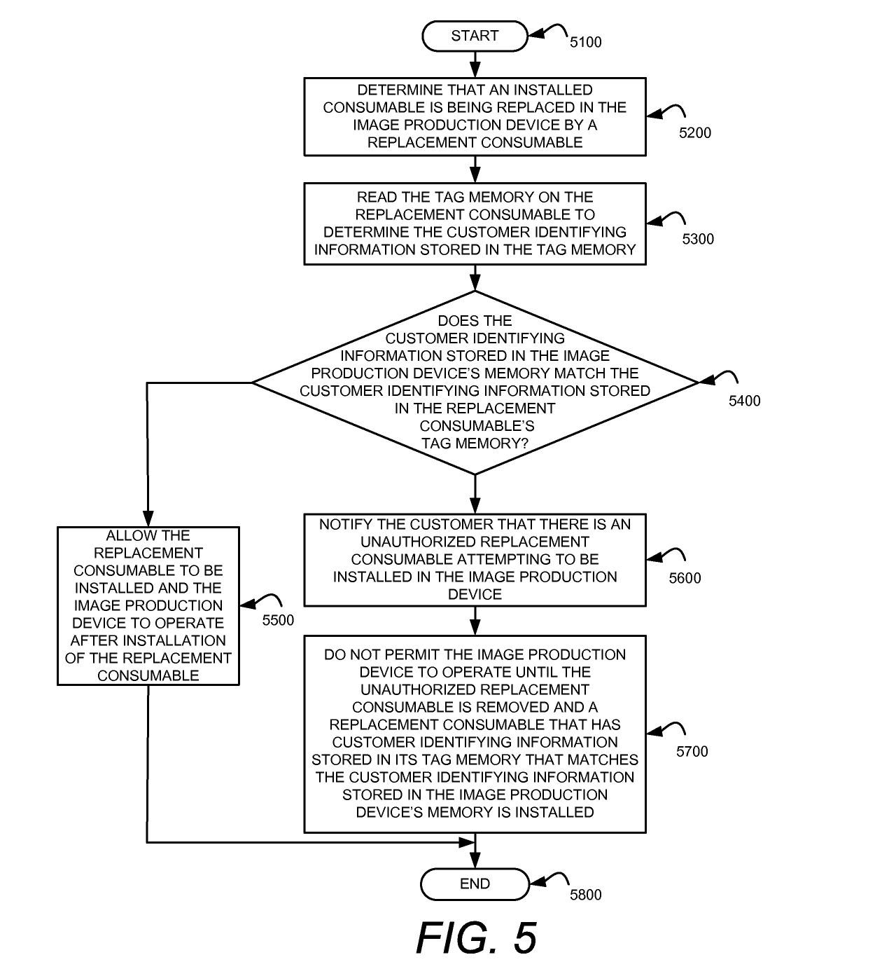

The operation of the consumable management unit 250 and an exemplary process for verifying the customer identifying information stored in a consumable with the customer identifying information stored in an image production device will be discussed below in relation to the flowchart in FIG. 5.

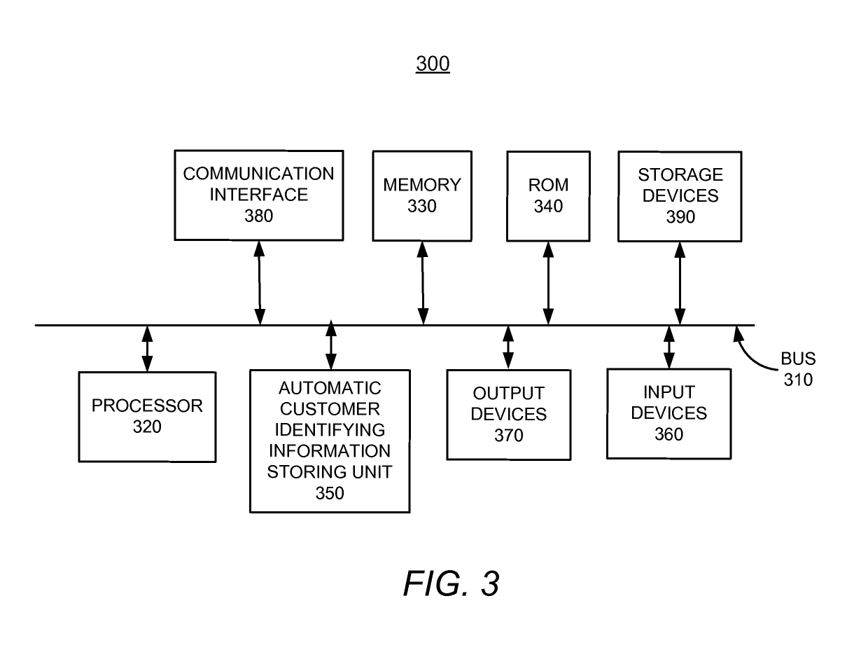

FIG. 3 is an exemplary block diagram of the consumable package processing unit 300 in accordance with one possible embodiment of the disclosure. The consumable package processing unit 300 may be a server, computer, handheld computer, mobile device, or processing device, for example. The consumable package processing unit 300 may include a bus 310, a processor 320, a memory 330, a read only memory (ROM) 340, an automatic customer identifying information storing unit 350, input devices 360, output devices 370, a communication interface 380, and storage device 390. Bus 310 may permit communication among the components of the consumable package processing unit 300.

Processor 320 may include at least one conventional processor or microprocessor that interprets and executes instructions. The memory 330 may be a random access memory (RAM) or another type of dynamic storage device that stores information and instructions for execution by processor 320. The memory 330 may also include a read-only memory (ROM) 340 which may include a conventional ROM device or another type of static storage device that stores static information and instructions for processor 320.

Input devices 360 may include one or more conventional mechanisms that permit a user to input information to the consumable package processing unit 300, such as a keyboard, a mouse, a pen, a voice recognition device, etc. Output devices 370 may include one or more conventional mechanisms that output information to the user, including a display, a printer, one or more speakers, or a medium, such as a memory, or a magnetic or optical disk and a corresponding disk drive.

Communication interface 380 may include any mechanism that facilitates communication via a network. For example, the communication interface 380 may include a modem. Alternatively, communication interface 380 may include other mechanisms for assisting in communications with other devices and/or systems.

ROM 340 may include a conventional ROM device or another type of static storage device that stores static information and instructions for processor 320. The storage devices 390 may augment the ROM 340 and may include any type of storage media, such as, for example, magnetic or optical recording media and its corresponding drive.

The consumable package processing unit 300 may perform such functions in response to processor 320 by executing sequences of instructions contained in a computer-readable medium, such as, for example, the memory 330. Such instructions may be read into the memory 330 from another computer-readable medium, such as a storage device or from a separate device via communication interface 380.

The consumable package processing unit 300 illustrated in FIG. 3 and the related discussion were intended to provide a brief, general description of a suitable communication and processing environment in which the disclosure may be implemented. Although not required, the disclosure will be described, at least in part, in the general context of computer-executable instructions, such as program modules, being executed by the consumable package processing unit 300, which may be a server, a computer, a handheld computer, and a processing device, for example.

Generally, program modules include routine programs, objects, components, data structures, etc. that perform particular tasks or implement particular abstract data types. Moreover, those skilled in the art will appreciate that other embodiments of the disclosure may be practiced in communication network environments with many types of communication equipment and computer system configurations, including personal computers, hand-held devices, multi-processor systems, microprocessor-based or programmable consumer electronics, and the like.

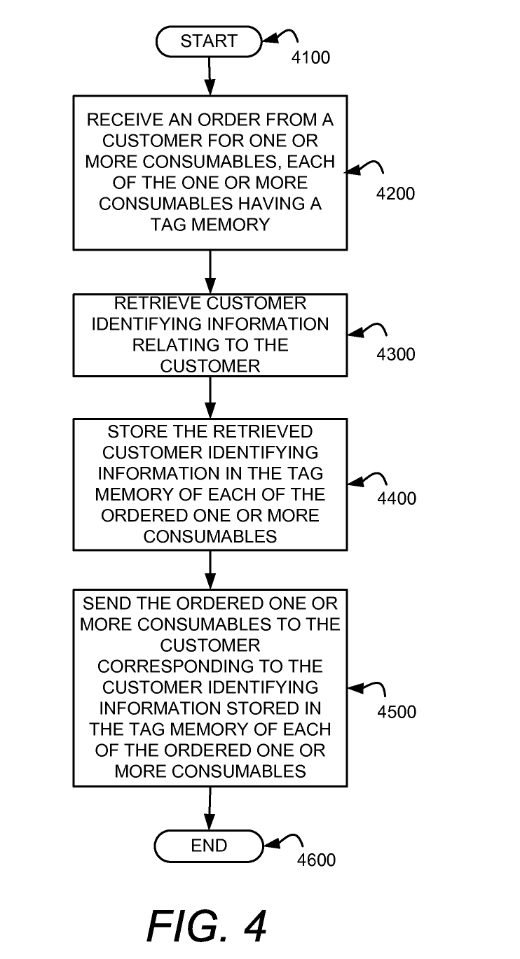

The operation of the automatic customer identifying information storing unit 350 and the automatic customer identifying information storing process will be discussed below in relation to the flowcharts in FIG. 4.

FIG. 4 is a flowchart of an exemplary process for storing a customer identifying information in a consumable's tag memory 140 to be used in an image production device in accordance with one possible embodiment of the disclosure. The customer identifying information may be stored at the manufacturing center or the distribution center for the consumables 130, for example. The customer identifying information may be determined based on whether the image production device 100 is owned by a user, owned by a manufacturer, owned by a distribution entity, or located in a particular geographic region, for example. The customer identifying information stored in the tag memory 140 of the consumable 130 my be matched to the customer identifying information stored in the image production device 100 once the consumable 130 is installed in the image production device 100.

The process may begin at step 4100 and may continue to step 4200 where the automatic customer identifying information storing unit 350 may receive an order from a customer for one or more consumables 130 through the communication interface 380, where each of the one or more consumables 130 has a tag memory 140.

At step 4300, the automatic customer identifying information storing unit 350 may retrieve customer identifying information relating to the customer. At step 4400, the automatic customer identifying information storing unit 350 may store the retrieved customer identifying information in the tag memory 140 of each of the ordered one or more consumables 130. At step 4500, the automatic customer identifying information storing unit 350 may send the ordered one or more consumables 130 to the customer corresponding to the customer identifying information stored in the tag memory 140 of each ordered one or more consumables 130. The process may then go to step 4600 and end.

It is notable that the retrieved customer identifying information in the tag memory 140 of each of the ordered one or more consumables 130 may be stored through packaging material. The tag memory 140 is capable of being activated through the packaging material to store the desired customer identifying information. The packaging material may include a box, paper, synthetic material, etc. for example.

FIG. 5 is a flowchart of an exemplary process for verifying the customer identifying information stored in a consumable 130 with the customer identifying information stored in an image production device 100 in accordance with one possible embodiment of the disclosure. The process may begin at step 5100 and may continue to step 5200 where the consumable management unit 250 may determine that an installed consumable is being replaced in the image production device 100 by a replacement consumable 130. At step 5300, the consumable management unit 250 may receive the customer identifying information stored in the tag memory 140 from the tag memory reading device 290.

At step 5400, the consumable management unit 250 may determine if the customer identifying information stored in the image production device's memory 230 matches the customer identifying information stored in the replacement consumable's tag memory 140. If the consumable management unit 250 determines that the customer identifying information stored in the image production device's memory 230 matches the customer identifying information stored in the replacement consumable's tag memory 140, then the process may go to step 5500 where the consumable management unit 250 may allow the replacement consumable 130 to be installed and the image production device 100 to operate after installation of the replacement consumable 130. The process may then go to step 5800 and end.

If at step 5400, the consumable management unit 250 determines that the customer identifying information stored in the image production device's memory 230 does not match the customer identifying information stored in the replacement consumable's tag memory 140, the process may go to step 5600 where the consumable management unit 250 may notify the customer that there is an unauthorized replacement consumable attempting to be installed in the image production device 100. At step 5700, the consumable management unit 250 may not permit the image production device 100 to operate until the unauthorized replacement consumable is removed and a replacement consumable 130 that has customer identifying information stored in its tag memory 140 that matches the customer identifying information stored in the image production device's memory 230 is installed. Note that this automated process may be overridden by a maintenance, manufacturing, distribution, or other consumable authority remotely or on-site to authorize the consumable 130 so that the image production device 100 may operate. The process may then go to step 5800 and end.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for storing a customer identifying information in a consumable used in an image production device, comprising:
receiving an order from a customer for one or more consumables, each of the one or more consumables having a tag memory;
retrieving customer identifying information relating to the customer;
storing the retrieved customer identifying information in the tag memory of each of the ordered one or more consumables; and
sending the ordered one or more consumables to the customer corresponding to the customer identifying information stored in the tag memory of each of the ordered one or more consumables.

2. The method of claim 1, wherein the customer identifying information is one of a sequence of numbers, a sequence of letters, a sequence of letters and numbers, a data glyph, a bar code, metering information and purchase information.

3. The method of claim 1, wherein the customer identifying information is stored at one of the manufacturing center and the distribution center.

4. The method of claim 1, wherein the retrieved customer identifying information in the tag memory of each of the ordered one or more consumables is stored through packaging material.

5. The method of claim 4, wherein the tag memory is capable of being activated through the packaging material to store the desired customer identifying information, the packaging material being at least one of a box, paper, and synthetic material.

6. The method of claim 1, wherein the customer identifying information is determined based on whether the image production device is one of owned by a user, owned by a manufacturer, owned by a distribution entity, and located in a particular geographic region.

7. The method of claim 1, wherein the customer identifying information stored in the tag memory of the consumable is matched to the customer identifying information stored in the image production device.

8. An apparatus for storing a customer identifying information in a consumable used in an image production device, comprising:
a communication interface that facilitates sending and receiving communications; and
an automatic customer identifying information storing unit that receives an order from a customer for one or more consumables through the communication interface, each of the one or more consumables having a tag memory, retrieves customer identifying information relating to the customer, stores the retrieved customer identifying information in the tag memory of each of the ordered one or more consumables, and sends the ordered one or more consumables to the customer corresponding to the customer identifying information stored in the tag memory of each ordered one or more consumables.

9. The apparatus of claim 8, wherein the customer identifying information is one of a sequence of numbers, a sequence of letters, a sequence of letters and numbers, a data glyph, a bar code, metering information and purchase information.

10. The apparatus of claim 8, wherein the customer identifying information is stored at one of the manufacturing center and the distribution center.

11. The apparatus of claim 8, wherein the retrieved customer identifying information in the tag memory of each of the ordered one or more consumables is stored through packaging material.

12. The apparatus of claim 11, wherein the tag memory is capable of being activated through the packaging material to store the desired customer identifying information, the packaging material being at least one of a box, paper, and synthetic material.

13. The apparatus of claim 8, wherein the customer identifying information is determined based on whether the image production device is one of owned by a user, owned by a manufacturer, owned by a distribution entity, and located in a particular geographic region.

14. The apparatus of claim 8, wherein the customer identifying information stored in the tag memory of the consumable is matched to the customer identifying information stored in the image production device.

15. A method of verifying a customer identifying information for a consumable to be used in an image production device, comprising:
determining that an installed consumable is being replaced in the image production device by a replacement consumable, the image production device having customer identifying information stored in its memory and the replacement consumable having a tag memory that stores customer identifying information;
reading the tag memory on the replacement consumable to determine the customer identifying information stored in the tag memory;
determining if the customer identifying information stored in the image production device's memory matches the customer identifying information stored in the replacement consumable's tag memory, wherein if it is determined that the customer identifying information stored in the image production device's memory does not match the customer identifying information stored in the replacement consumable's tag memory,
notifying the customer that there is an unauthorized replacement consumable attempting to be installed in the image production device, and
not permitting the image production device to operate until the unauthorized replacement consumable is removed and a replacement consumable that has customer identifying information stored in its tag memory that matches the customer identifying information stored in the image production device's memory is installed,
wherein if it is determined that the customer identifying information stored in the image production device's memory matches the customer identifying information stored in the replacement consumable's tag memory,
allowing the replacement consumable to be installed and the image production device to operate after installation of the replacement consumable.

16. The method of claim 15, wherein the customer identifying information is one of a sequence of numbers, a sequence of letters, a sequence of letters and numbers, a data glyph, a bar code, metering information and purchase information.

17. The method of claim 15, wherein the customer identifying information is determined based on whether the image production device is one of owned by a user, owned by a manufacturer, owned by a distribution entity, and located in a particular geographic region.

18. An image production device, comprising:
a memory that stores customer identifying information for the image production device;
a tag memory reading device that reads a tag memory on a replacement consumable to determine the customer identifying information stored in the tag memory; and
a consumable management unit that determines that an installed consumable is being replaced in the image production device by a replacement consumable, receives the customer identifying information stored in the tag memory from the tag memory reading device, determines if the customer identifying information stored in the image production device's memory matches the customer identifying information stored in the replacement consumable's tag memory, wherein if the consumable management unit determines that the customer identifying information stored in the image production device's memory does not match the customer identifying information stored in the replacement consumable's tag memory,
the consumable management unit notifies the customer that there is an unauthorized replacement consumable attempting to be installed in the image production device, and does not permit the image production device to operate until the unauthorized replacement consumable is removed and a replacement consumable that has customer identifying information stored in its tag memory that matches the customer identifying information stored in the image production device's memory is installed,
wherein if the consumable management unit determines that the customer identifying information stored in the image production device's memory matches the customer identifying information stored in the replacement consumable's tag memory,
the consumable management unit allows the replacement consumable to be installed and the image production device to operate after installation of the replacement consumable.

19. The image production device of claim 18, wherein the customer identifying information is one of a sequence of numbers, a sequence of letters, a sequence of letters and numbers, a data glyph, a bar code, metering information and purchase information.

20. The image production device of claim 18, wherein the customer identifying information is determined based on whether the image production device is one of owned by a user, owned by a manufacturer, owned by a distribution entity, and located in a particular geographic region.
